(19) United States
(12) Patent Application Publication
(10) Pub. No.: US 2010/0257774 A1
(43) Pub. Date: Oct. 14, 2010

(54) Alexxon rat tracking station and method for rat control

(76) Inventors: Heide Alexandra Middlebrook, Wellington, FL (US); Beverly Dianne Middlebrook, Wellington, FL (US); Christopher Todd Middlebrook, Wellington, FL (US)

Correspondence Address: Heide Middlebrook;RMB 308 Ste 4, 13833 Wellington Tr., Wellington, FL, 33414, US

(21) Appl. No.: 12/385,483

(22) Filed: Apr. 9, 2009

(51) Int. Cl. A01M 25/00

(52) U.S. Cl. 43/131

(57) ABSTRACT

An apparatus for the delivery of toxicant to rats includes a conduit having an entry and an exit for rats, installed into an area determined to be suitable for rat control. A toxicant is placeable and contained in the conduit such that rats will contact the toxicant when passing through the conduit. The apparatus will be attended to to ensure the area is deemed rat free. Methods for using the apparatuses are also described.

### FIELD OF THE INVENTION

The present invention relates to a method and the apparatus for the control of rats.

### DISCUSSION OF THE PRIOR ART

Many forms of rat control have been attempted. While many systems are successful for vermin such as termites, cockroaches, and rodents such as mice, it has proven to be extremely difficult to control rat populations. This difficulty is due to the fact that rats are social and intelligent animals, and can associate a trap or bait station with the death of a member of the group that has come into contact with a known method of extermination. The remaining members of the group then avoid the trap and bait station, preventing their capture.

Further more, as rats are nocturnal animals, it is sometimes difficult to determine the number of rats present in a particular area. As a result, if several rats are captured in a particular area, it may appear that the rat population in the area has been eliminated, when in fact the problem has not been resolved. When rats are subsequently noticed in the same area, it is often erroneously believed that a new rat population has moved into the area, whereas in reality the original population was never eliminated.

Rats and some other rodents do not like to cross open spaces, and are typically found in enclosed spaces such as in the voids between the walls of a building and attic spaces. Many known bait stations therefore employ housing or other confined spaces that a rodent is likely to be attracted into so that the rodent contacts the poison, and then ingests it. Such known bait stations include those described in U.S. Pat. Nos. 4,349,981, 4,753,032, 4,835,902, 4,831,775 and 4,905,407 to Sherman, U.S. Pat. No. 4,908,976 to Dagenais, U.S. Pat. No. 4,825,581 to Daily, U.S. Pat. No. 5,136,803 to Sykes et al., U.S. Pat. No. 4,132,026 to Dodds and U.S. Pat. No. 5,027,548 to Anderson, among others.

Such known bait stations can be complicated and difficult to install particularly if a person has to carry a bait station to an attic or roof rafter, or place the bait station into a confined space. It is often difficult to load the poison into a bait station after it has been placed into a selected location, and if the poison is pre-loaded into a bait station, it can spill during placement. Even if the bait station can be placed without spillage of the poison, rats can learn that it contains poison, and a colony can easily avoid the bait station after the death of one or two members of the colony.

### SUMMARY OF THE INVENTION

One embodiment of the invention relates to the delivery of the toxicant to the rat. The custom molded apparatus is ridged all the way around to provide strength as well as containment of the toxicant. Attached inside the unit is an aluminum runway also ridged where the toxicant is placed along with an attractant mixture. At either end of the unit is a custom vinyl baffle reinforced with a rigid plastic baffle behind it. These baffles also serve to push the toxicant into the rat's fur for him to deliver it back to the nest. Also contained inside the apparatus to contain the toxicant are more rigid plastic baffles. The unit is clear in order that the rat pass thru without shyness.

The toxicant may include an active ingredient which forms less then 2% of the toxicant. In one arrangement the active ingredient is less then 0.2% of the toxicant. The active ingredient may be Diphenylacetyl-1,3-indandione. The active ingredient may be any suitable poison, anticoagulant, or other rodenticide or insecticide.

The method of placement of the apparatus may include a plurality of units into the selected area. The method may also include the step of securing the unit into a desired location within the area. The location for placement of the unit may be selected based on the behavioral patterns of the rats present. The locations can be for junctures of walls and floors, above suspended ceilings, beneath raised floors, and crawl spaces. Alternative locations may be external locations, such as in and around barns, silos, and other storage facilities, alongside buildings underneath buildings, along docks or in marinas, in subways or sewer systems, within fields of crops or pasture, in farming and recreational areas, around schools, factories, hospitals and places of work, yards and gardens of buildings, and any other suitable location.

A further step of the method of placement may involve selecting a second area for rat management adjoining the first area when the first area is deemed rat free, repeating the method in the second area until the second area is deemed rat free and providing a plurality of the toxicant receptacles around the periphery of the first and second adjoining area, to expand the periphery of the managed area.

### BRIEF DESCRIPTION OF THE DRAWINGS

There are shown in the drawings embodiments, which are presently preferred, it being understood, however, that the invention is not limited to the precise arrangements shown.

FIG. 1 is a front view of one embodiment of the invention.

FIG. 2 is a front view of one embodiment of the invention showing the interior of the invention.

FIG. 3 is a perspective view of another embodiment of the invention.

FIG. 4 is a side view of the embodiment of the invention.

### DETAILED DESCRIPTION OF THE PREFERRED EMBODIMENTS

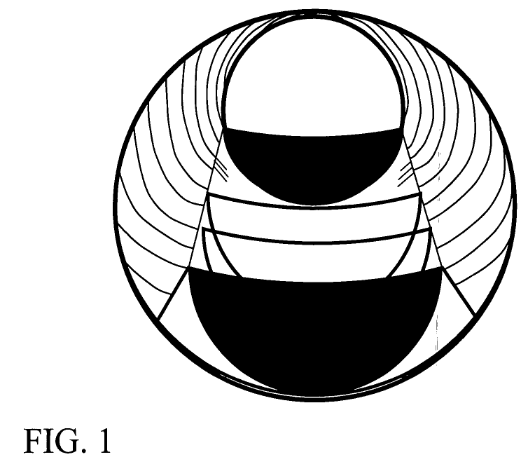

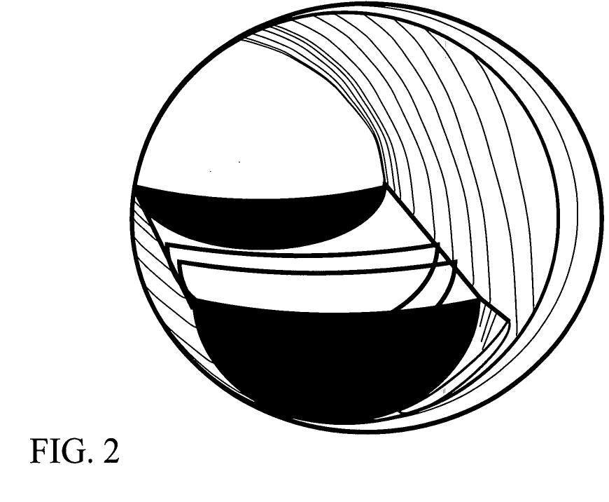

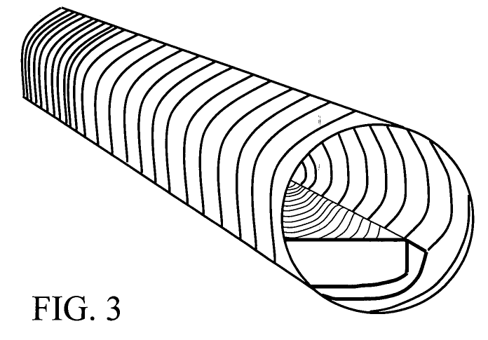

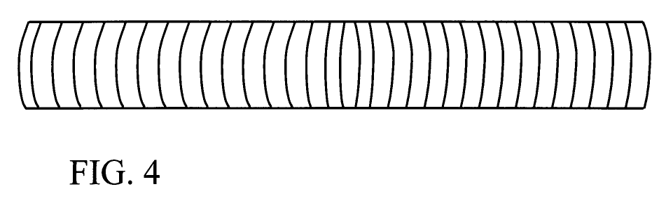

Referring to the drawings (FIGS. 1 to 4) the conduit units are formed out of a rigid plastic material rigid on the inside (FIG. 3) to join with an expanded metal insert (FIG. 2) Both pieces are attached so as to provide a cradle for the chosen toxicant to be contained within the conduit. The conduit may have any suitable length from 12″ to 48″ (FIG. 4). Different lengths of will be appropriate in different circumstances, such as desired location of the conduit and type of rat infestation.

The conduit (FIG. 4) may be sized to permit rats to pass through it without a large amount of clearance above or to the sides of the rat. Thus different sized rodents such as Norway rats, roof rats, and cotton rats. A suitable width of conduit (FIG. 1) for use with rats in approximately 3-4 inches or 8 inches for use with large rats, but maybe as large as 12 inches.

The conduit (FIG. 1) is also fitted with a pliable vinyl baffle reinforced with a rigid plastic backing at each end to insure containment of the toxicant. The end baffles as well as the (FIG. 1) interior ridged plastic baffles also ensure that the toxicant is delivered into the fur of the rat as the rat passes thru and out the unit to return to the nest.

The toxicant is measured and scooped into the center of the conduit—upon initial installation or as needed to be replenished during service visits.

The toxicant may include any suitable rodenticide, insecticide, or other poison. A preferred toxicant for use in controlling rat populations contains 2% or less of an active ingredient. A preferred active ingredient is an anticoagulant. A preferred formulation has approximately 0.2% or less of an anticoagulant. A preferred anticoagulant is 2-Diphenylacetyl-1,3-indandione is available under the name Ditrac (registered trademark) tracking powder from BELL Laboratories, Inc., Madison, Wis.

It has been found that a low concentration of active ingredient causes death of the rat a long time after contact with the toxicant. While it may seem counterintuitive to allow the rat to remain alive for several days or more the contact with the toxicant, this is advantageous with intelligent animals such as rats, because this arrangement prevents the rats from easily associating the toxicant container with the death of members of the rat population. The remaining members of the population there after do not avoid the toxicant, causing death to a greater portion of the population than would otherwise be the case.

Any of the devices according to the invention may be secured into place by any suitable means. Any suitable securement means may be used such as adhesives, nails, screw, hook and loop fastener, or any other means.

The devises according to the invention may be used for rat control. Particular success has been achieved with rat populations enabling an area to be deemed free of rats. In order to prevent repeat infestations, the invention also includes a method of managing an area, which includes using a plurality of the devices in an area until the area is deemed free of rats. After the area is deemed free of rats, it is no loner necessary to keep devices according to the invention throughout the whole area, particularly with rats which do not travel long distances from there original colonies to establish new colonies. Instead, in order to prevent other rat populations from moving into the cleared area, a plurality of devices may be set up around periphery of the cleared area. This will ensure that any rats moving into the area will pass one or more of the devices, because animals such as rats do not simply invade an area, but move slowly and cautiously into an area and are very likely to investigate and conduits in there path.

Typically, once an area is cleared of rats, it is desirable to clear a neighboring area of rats so that very large infestations can be cleared in a controlled manner without the need to blanket the area with a very large number of devices. When the neighboring area is deemed to be clear of rats, the periphery of devices can be expanded to include both the first cleared area and the second cleared area. This can be continued until the entire area to be controlled is designated free of rats.

It should be understood that the examples and embodiments described herein are for illustrative purposes only and that various modifications or changes in light there of will be obvious to persons skilled in the art, and that such modifications or changes are to be included with in the spirit and preview of this application. Moreover the invention can take other specific forms without departing from the spirit or essential attributes thereof.

What is claimed is:

1. An apparatus for the delivery of toxicant to rats comprising: a custom molded polyethylene conduit providing an entry and exit for the rat.

2. An apparatus wherein the conduit is installed in an area: determined to be suitable for rat control.

3. An apparatus where in a toxicant is placeable in the conduit.

4. An apparatus in order that rats will contact the toxicant passing while passing through the conduit.

5. The apparatus in claim 1, wherein said conduit is comprised of ridges all the way around.

6. The apparatus in claim 1, wherein said conduit includes within an appropriate number of rigid plastic baffles so as to contain the toxicant.

7. The apparatus in claim 1, wherein said metal runway with ridges is attached directly to the polyethylene conduit to contain the toxicant.

8. The apparatus in claim 1, wherein the apparatus is refillable with the toxicant.

9. The apparatus in claim 1, where said conduit is replaceable.

10. The apparatus in claim 1, wherein said conduit includes a semi-circular vinyl baffle at each end reinforced with a rigid plastic baffle support connected behind it to enhance containment of the toxicant.

11. The apparatus in claim 3, wherein said toxicant comprises an active ingredient which forms less than approximately 2% of the toxicant.

12. The apparatus of claim 11, wherein said active ingredient comprises less than approximately 0.2% of the toxicant.

13. The apparatus of claim 11, wherein said active ingredient is an anti-coagulant.

14. The apparatus of claim 11, wherein said active ingredient is 2-Diphenylacetyl-1,3-indandione.

15. A method for the delivery of toxicant to rats, comprising the steps of providing a conduit having an entry an exit for rats; locating the conduit in an area selected for rat management; and placing the toxicant within the conduit.

16. The method of claim 15, further comprising the step of placing a plurality of conduit into the selected area.

17. The method of claim 15, further comprising the step of securing the conduit into a desired location within the selected area.

18. The method of claim 15, further comprising the step of selecting the placement of the conduit based on the behavioral patterns of the rat.

19. The method of claim 18, wherein the locations are selected from the group consisting of voids between wall of a building, attics, roof spaces, basements, junctures of walls and floors, above suspended ceilings, beneath raised floors, crawl spaces, in and around barns, silos and other storage facilities, alongside buildings, underneath buildings, along docks or in marinas, in subways or sewer systems, within fields or crops or pasture, in farming and recreational, around schools, factories, hospitals and places of work, and yards and gardens of buildings.

20. A method for the management of rats from an area comprising the steps of; providing a toxicant having less than approximately 2% active ingredient in a toxicant receptacle; locating a plurality of the toxicant receptacles in a first area contain rats; and managing of the first area by replenishment of the toxicant receptacles.

21. The method of claim 20, wherein the active ingredient of the toxicant comprises less than approximately 0.2% of the toxicant.

22. The method of claim 20, wherein the active ingredient is an anti-coagulant.

23. The method of claim 20, wherein the active ingredient is 2-Diphenylacetyl-1,3-indandione.

24. The method of claim 20, further comprising removing toxicant receptacle from within the first area, and location a plurality of toxicant receptacles around the periphery of the first area when the first area is deemed rat free.

25. The method of claim 20, further comprising selecting a second area for rat management adjoining the first area when the first area is deemed rat free, repeating the method in the second area until the second area is deemed rat free and providing a plurality of the toxicant receptacles around the periphery of the first and second adjoining areas, there by expanding the periphery managed area.
